(19) United States
(12) Patent Application Publication
(10) Pub. No.: US 2019/0283816 A1
(43) Pub. Date: Sep. 19, 2019

(54) Track Mat

(71) Applicant: Jason Andrew Luburgh, Zanesville, OH (US)

(72) Inventor: Jason Andrew Luburgh, Zanesville, OH (US)

(21) Appl. No.: 15/919,888

(22) Filed: Mar. 13, 2018

(51) Int. Cl. B62D 55/088

(52) U.S. Cl. CPC B62D 55/0882

(57) ABSTRACT

The invention is a track mat attachment for a tracked vehicle designed to remove mud and debris from the space between the tracks. The mat that fits flush with the undercarriage wall inside the area of the tracks where mud and debris build up. The mat is the shape of the undercarriage wall with angled out lip at the top of the mat with curve idler openings where the idlers are for the vehicle. The mat will have eyelets at the bottom which can be attached to a rope, chain or cord to pull the mat out of where it is on the undercarriage. When the mat is pulled out it will bring out all of the mud and debris that has been deposited there. The mat will be mad of a hard sturdy material and may have supports that help it maintain its shape and give it the ability to pull the mud out for the location.

### CROSS-REFERENCES TO RELATED APPLICATIONS (IF ANY)

None.

### BACKGROUND

### 1. Field of the Invention

The invention relates to a track mat that is used to clean out built up around the tracks of a tracked type vehicles.

### 2. Description of Prior Art

Tracked vehicles such as bulldozers when used in muddy conditions can have an extreme buildup of mud and debris around the tracks and between the tracks. To clean this out it can take over an hour to do manually. The current tools are shovels and spades with high speed water hose. It can be time intensive and waste water if used, costing the company money.

There is still room for improvement in the art.

### SUMMARY OF THE INVENTION

The present invention is a track mat attachment for a tracked vehicle. It is designed to remove mud and debris from the space between the tracks of a tracked type vehicles like a bulldozer or excavator.

The invention is a mat that fits flush with the undercarriage wall inside the area of the tracks where mud and debris build up. The mat is the shape of the undercarriage wall with angled out lip at the top of the mat with curve idler openings where the idlers roller are for the vehicle. The mat may have cut out portions for a step for those vehicles that need it.

The mat, in the preferred embodiment, will have eyelets at the bottom which can be attached to a rope, chain or cord to pull the mat out of where it is on the undercarriage. When the mat is pulled out it will bring out all of the mud and debris that has been deposited there. This makes for a quick and easy cleaning of the under carriage area and reducing the cleaning time by over 90 percent.

The mat will be made of a light weight sturdy material and may have supports that help it maintain its shape and give it the ability to pull the mud out for the location.

The current invention is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows the mat's placement in regards to a tracked type vehicle;

FIG. 2 shows a standard mat;

FIG. 3 shows another standard mat with step cut outs;

FIG. 4 shows a mat for a high track vehicle;

FIG. 5 shows another embodiment for a high track configuration; and

FIG. 6 shows the mat removing built up mud and debris.

### DESCRIPTION OF THE PREFERRED EMBODIMENT

There are a number of significant design features and improvements incorporated within the invention.

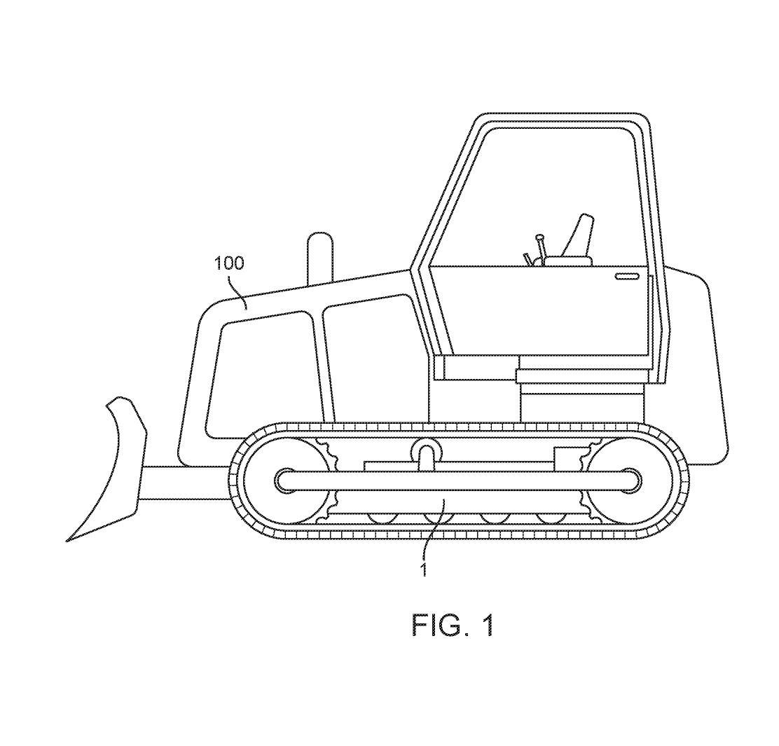

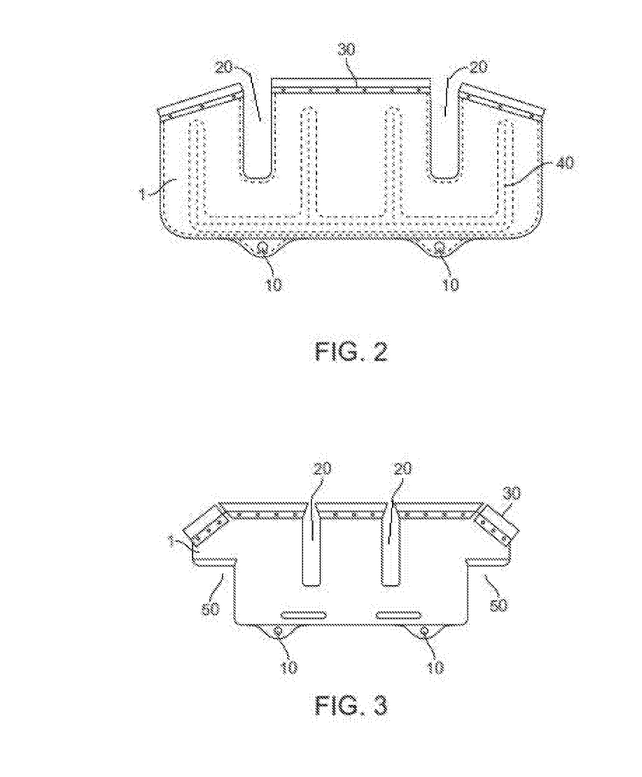

As shown in FIGS. 1 through 5, the present invention is a track mat 1 attachment for a tracked type vehicle 100. It is designed to remove mud and debris 200 from the space between the tracks of a tracked type vehicles like a bulldozer or excavator.

The invention is a mat that fits flush with the undercarriage wall inside the area of the tracks where mud and debris 200 builds up. The mat 1 is in the shape of the undercarriage wall 120 with angled out lip 30 at the top of the mat 1 with curve idler openings 20 where the idlers are for the vehicle. The mat 1 may have cut out portions 50 for steps for those vehicles that need it as shown in FIG. 3.

The mat 1, in the preferred embodiment, will have eyelets 10 at the bottom which can be attached to a rope, chain or cord 70 to pull the mat out of where it is on the undercarriage. When the mat 1 is pulled out it will bring out all of the mud and debris 200 that has been deposited there. This makes for a quick and easy cleaning of the under carriage area and reducing the cleaning time by over 90 percent.

The mat 1 will be made of a sturdy material like a hard plastic and may have supports 40 that are built into the mat 1 that help it maintain its shape and give it the ability to pull the mud out of the location. The mat 1 is flat and can be made with various thicknesses. The supports 40 can reduce the amount of thickness needed to provide the proper structural support.

The mats 1 can be reusable or designed to be single use.

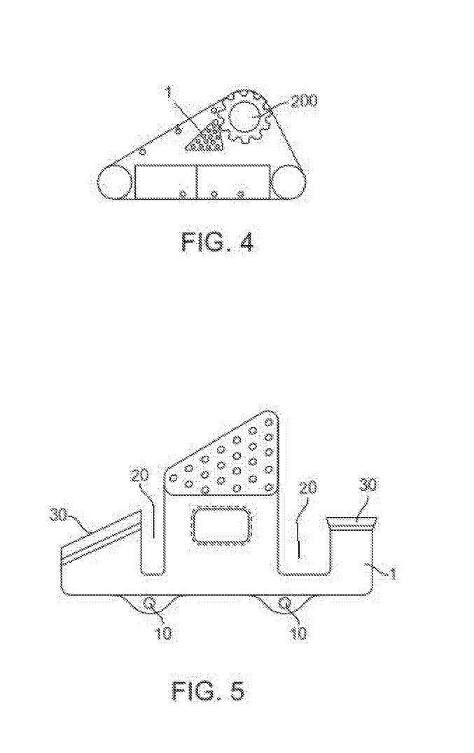

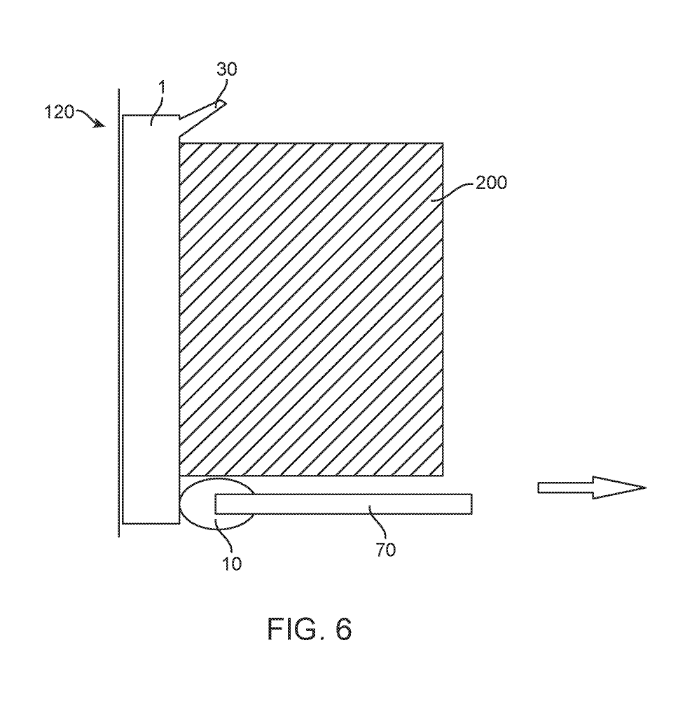

As shown in FIG. 4, the mat 1 can be used with a triangular shaped track as well. The shape of the mat 1, as shown in FIG. 5 is more triangular in shape but it still has the lip 30 on the top of the mat 1 as well as the eyelets 10 at the bottom of the mat 1.

The mat 1 may have magnets 80 located at the bottom of the mat 1 in the preferred embodiment that can secure the mat 1 to its proper location.

Operation

The mat 1 is placed against the carriage wall 120 prior to the vehicle being used. As shown in FIG. 6, the mud and debris 200 builds up against the mat 1 instead of the vehicle under carriage wall 120. When it is time to clean the tract area the person cleaning it pulls that mat 1 away from the wall 120. In the preferred embodiment, this is done by pulling on ropes or chains 70 attached to the eyelets 10 at the bottom. This action pulls all the mud and debris 200 away from the carriage wall 120 and from the vehicle.

Numerous materials can be used to make the mat 1 such as hard plastic, magnetic rubber material, fire resistant material as well as any other sturdy material.

The mat 1 can be customizable with different colors or a company logo, or company endorsements. The mat 1 can also have LEDs that can light the mat 1 for safety.

Other sizes and shapes of mats 1 can be created to protect other vehicles where dirt and debris build up can occur.

The mat 1 could have a theft-proof lock placed on the mat 1.

The current invention will improve productivity and reduce operating costs.

In this description, references to “one embodiment” mean that the feature being referred to may be included in at least one embodiment of the invention. Moreover, separate references to “one embodiment” or “some embodiments” in this description do not necessarily refer to the same embodiment.

The invention may include any variety of combinations and/or integrations of the features of the embodiments described herein. Although some embodiments may depict serial operations, the embodiments may perform certain operations in parallel and/or in different orders from those depicted. Moreover, the use of repeated reference numerals and/or letters in the text and/or drawings is for the purpose of simplicity and clarity and does not in itself dictate a relationship between the various embodiments and/or configurations discussed. The embodiments are not limited in their applications to the details of the order or sequence of steps of operation of methods, or to details of implementation of devices, set in the description, drawings, or examples. Moreover, individual blocks illustrated in the figures may be functional in nature and do not necessarily correspond to discrete hardware elements.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-11. (canceled)

12. A device to remove mud and debris comprising:
a flat mat with a top and a bottom in the shape of an undercarriage wall with angled out lip at the top of the mat with curve idler openings the extend down from the top of the mat with a plurality of eyelets on the bottom of the mat where the mat is placed against the undercarriage wall and where the curve idler openings are positioned to fit around idlers on a vehicle.

13. The device according to claim 12 comprising:
having the mat be made of a hard plastic.

14. The device according to claim 12 comprising:
having supports built into the mat.

15. The device according to claim 12 comprising:
being reusable.

16. The device according to claim 12 comprising:
being single use.

17. (canceled)

18. (canceled)

19. (canceled)

20. The device according to claim 12 comprising:
having a pulling means attached to the eyelet.

21. (canceled)

22. The device according to claim 12 comprising:
having an area to be protected where the shape of the mat will match the shape of the area to be protected.

23. (canceled)

24. A process to remove mud and debris comprising:
using the device from claim 12.

25. The process according to claim 24 comprising:
having an area to be protected and placing the mat in the area to be protected.

26. The process according to claim 24 comprising:
having a pulling means attached to a respective eyelet of the plurality of eyelets;
and pulling on the pulling means to pull the mat after from the area to be protected.
